(19) United States
(12) Patent Application Publication
(10) Pub. No.: US 2026/0195636 A1
(43) Pub. Date: Jul. 9, 2026

(54) AUTOMATED GENERATION OF EXPLANATIONS FOR PREDICTIONS IN TEXT-BASED ARTIFICIAL INTELLIGENCE USE CASES

(71) Applicant: SAP SE, Walldorf (DE)

(72) Inventor: Chinmay Kakatkar, München (DE)

(21) Appl. No.: 19/009,351

(22) Filed: Jan. 3, 2025

(51) Int. Cl. G06N 20/00

(52) U.S. Cl. CPC G06N 20/00

(57) ABSTRACT

In some implementations, there is provided a computer-implemented method comprising receiving, by a processor, at least a first text-based input, determining, by the processor and using a first machine learning model, at least a first predicted result corresponding to at least the first text-based input, training a second machine learning model on at least the first text-based input and at least the first corresponding predicted result, determining, by the trained second machine learning model, an explanation for at least the first predicted result determined by the first machine learning model, and outputting, to a user interface of user equipment, the explanation for at least the first predicted result.

### TECHNICAL FIELD

The present disclosure relates to generating insights by deriving explanations for artificial intelligence-based predictions from textual inputs.

### BACKGROUND

In manufacturing, finance, sales, procurement, information technology (IT), and other areas, machine learning (ML) models are used to predict result given text-based inputs. A user can interact with a user interface of a computing system to log an issue or submit a query and can receive from an ML model a predicted result. Such computing systems for generating notifications may accept a text-based description of an issue as an input. For example, in the case of asset maintenance at a manufacturing plant, when a user of the computing system notices a maintenance issue, the user may enter a text-based input into a user interface of the computing system to predict a result based on the input. The predicted result can be used or otherwise referenced by an employee (e.g., a technician) responding to the issue notification.

### SUMMARY

In some embodiments, there is provided a computer-implemented method. The method may include receiving, by a processor, at least a first text-based input; determining, by the processor and using a first machine learning model, at least a first predicted result corresponding to at least the first text-based input; training a second machine learning model on at least the first text-based input and at least the first corresponding predicted result; determining, by the trained second machine learning model, an explanation for at least the first predicted result determined by the first machine learning model; and outputting, to a user interface of user equipment, the explanation for at least the first predicted result.

In some variations, the second machine learning model may be an explanatory model. In some implementations, the explanatory model may be configured to generate a global explanation for at least the first predicted result. The explanatory model may be a topic model. In further implementations, the topic model may be a latent Dirichlet allocation model. The method may further include by the topic model, determining, for at least the first text-based input, a plurality of topics potentially associated with at least the first text-based input; determining, for at least the first text-based input, a topic of the plurality of topics having a highest frequency important score associated with at least the first predicted result; and outputting to the user interface, as the global explanation, the topic of the plurality of topics having the highest frequency importance score being associated with at least the first predicted result. The explanatory model may be configured to generate a local explanation for at least the first predicted result. The explanatory model may be configured to generate the local explanation for at least the first predicted result by tokenizing at least the first text-based input into a plurality of tokens. The method may further include for the plurality of tokens: determining, by the processor and using the first machine learning model, at least a first token-level predicted result; comparing at least the first token-level predicted result to at least the first predicted result to determine a closeness between at least the first token-level predicted result and at least the first predicted result; and outputting to the user interface, as the local explanation, the token-level predicted result having a smallest closeness between the token-level predicted result and at least the first predicted result. The method may further include generating, by the explanatory model, the local explanation for at least the first predicted result by: masking at least the first text-based input to create at least a first masked text-based input; determining, for at least the first masked text-based input, at least a first masked predicted result; comparing at least the masked predicted result to at least the first predicted result to determine a closeness between at least the first masked predicted result and at least the first predicted result; and outputting to the user interface, as the local explanation, the masked predicted result having a smallest closeness between the masked predicted result and at least the first predicted result.

In some embodiments, there is provided a system including at least one processor; and at least one memory including instructions which when executed by the at least one processor causes operations including: receiving, by the at least one processor, at least a first text-based input; determining, by the at least one processor and using a first machine learning model, at least a first predicted result corresponding to at least the first text-based input; training a second machine learning model on at least the first text-based input and at least the first corresponding predicted result; determining, by the trained second machine learning model, an explanation for at least the first predicted result determined by the first machine learning model; and outputting, to a user interface of user equipment, the explanation for at least the first predicted result.

In some variations, the second machine learning model is an explanatory model. In some implementations, the explanatory model may be configured to generate a global explanation for at least the first predicted result. The explanatory model may be a topic model. The explanatory model may be configured to generate a local explanation for at least the first predicted result.

In some embodiments, there is provided a non-transitory computer-readable medium including instructions which when executed by at least one processor causes operations comprising: receiving, by the at least one processor, at least a first text-based input; determining, by the at least one processor and using a first machine learning model, at least a first predicted result corresponding to at least the first text-based input; training a second machine learning model on at least the first text-based input and at least the first corresponding predicted result; determining, by the trained second machine learning model, an explanation for at least the first predicted result determined by the first machine learning model; and outputting, to a user interface of user equipment, the explanation for at least the first predicted result.

In some variations, the second machine learning model is an explanatory model. In some implementations, the explanatory model may be configured to generate a global explanation for at least the first predicted result. The explanatory model may be a topic model. The explanatory model may be configured to generate a local explanation for at least the first predicted result.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods may be implemented by one or more data processors either within a single computing system or distributed among two or more computing systems. Such computing systems may be connected and may exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A illustrates a user interface for inputting a text-based input and receiving an explanation of an AI-based prediction of a result given the input, in accordance with some example implementations of the current subject matter;

FIG. 1B illustrates text-based inputs that may be entered into the user interface of FIG. 1A, in accordance with some example implementations of the current subject matter;

FIG. 2 illustrates a block diagram of a system that determines explanations for AI predictions having text-based inputs, in accordance with some example implementations of the current subject matter;

FIG. 3 illustrates a table used to determine global explanations for predictions based on text-based inputs via a topic model, in accordance with some example implementations of the current subject matter;

FIG. 4 illustrates a diagram of a process flow for determining explanations for AI predictions having text-based inputs, in accordance with some example implementations of the current subject matter;

FIG. 5 illustrates a block diagram of another example of a system configured to determine explanations for AI predictions having text-based inputs, in accordance with some example implementations of the current subject matter; and

FIG. 6 illustrates masking schema for determining local explanations for predictions based on text-based inputs in accordance with some example implementations of the current subject matter.

### DETAILED DESCRIPTION

Various systems have needs for computing systems that generate various types of notifications to alert employees. Such systems may be found in finance, sales, procurement, and manufacturing, among other fields. For example, in finance, a user may note a suspicious transaction and may enter a description thereof into a computing system as described herein. Such computing systems can make a prediction regarding the legitimacy of the transaction and can further provide explanations as to why a particular transaction may be marked as legitimate or fraudulent. Applying such computing systems as described herein to finance may thus help fraud analysts better respond to transactions that are potentially fraudulent. As another example, in sales, computing systems can make predictions regarding how promising a sales lead may be by analyzing text-based interactions with potential customers. Such computing systems can further provide explanations as to why a particular sales lead may be deemed promising or not. Applying such computing systems as described herein to sales may thus help salespersons better spend time and resources targeting promising sales leads. As another example, in procurement, computing systems as described herein can predict whether a supplier is low-risk or high-risk by analyzing reports describing risk assessment. Such computing systems can further provide explanations as to why a particular supplier was given a particular risk level. Applying such computing systems as described herein to procurement may thus help procurement managers to take proactive measures in handling supply chain problems. As an additional example, and as described further throughout the specification, computing systems as described herein may be used in manufacturing. In manufacturing settings, a user of the computing system as described herein may note a maintenance issue that needs addressing and may use the computing system to generate the notification. The notification may be, for example, a damage code that describes the manufacturing issue and a potential solution. The computing systems described herein can further provide explanations as to why a particular damage code was predicted for a given maintenance issue. Applying such computing systems as described herein to manufacturing may thus help repair technicians respond more efficiently to manufacturing issues.

The user of computing systems as described herein may interact with the computing system via a user interface. The user-interface of the computing system may comprise any number of fields that are configured to be filled in by the user generating the maintenance notification. Such fields may provide additional spaces for a user of the computing system to provide an input, e.g., an input describing a maintenance issue in a manufacturing setting. Based on the text-based input describing the maintenance issue and the information provided by the user in the other fields, the system may determine an output that describes or summarizes the maintenance issue. The output may be, for example, a damage code. The damage code may be output or predicted by the computing system via a machine-learning (ML) model. The ML model may take as an input the text-based input provided by the user who initially generated the maintenance notification and may output the damage code based on the input.

While it may sometimes be possible to respond to a maintenance notification given only the text-based input describing the issue, the information provided into additional inputs fields by the user of the computing system, and the knowledge of the damage code, in other instances it may be that the technician that is ultimately responsible for responding to the maintenance notification (i.e., servicing the maintenance request corresponding to the notification) could better respond to the notification if they understood why a particular damage code has been output by the system. In other words, the technician could better respond to the notification if they had an explanation for why a particular damage code was output by the ML model of the computing system.

While the information provided by the user of the computing system into the additional fields may help to provide a sort of explanation for the damage code output by the computing system, it may be time consuming for a user to fill in every field in the user interface. This may be the case in particular when some or any of the fields are to be filled in with information that is mandatory for the maintenance notification to be generated. This difficulty may be even more pronounced when the user that notices the need for the maintenance lacks the technical expertise of the technician that may ultimately respond to the maintenance notification. Such a user may lack the knowledge or vocabulary to fill out every field in the user interface with the information that is necessary and helpful for the technician or repairperson that must ultimately respond to the maintenance notification.

To prevent wasting resources and ensure that a maintenance request can be efficiently and appropriately serviced, it is important to clarify the damage code and the reason behind its prediction early in the maintenance process.

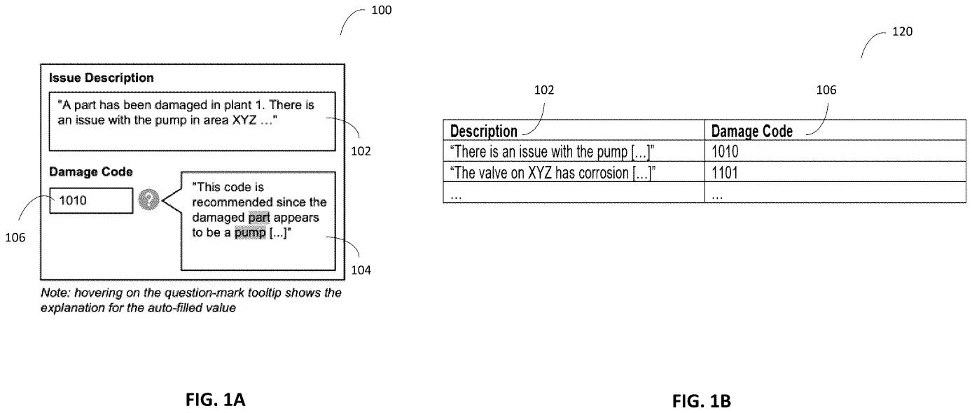

FIG. 1A illustrates an example of a user interface 100 into which a user of the systems described herein may enter a text-based input 102 in order to receive an explanation 104 for a predicted result 106, such as a damage code. In some implementations, the text-based input 102 may be a description of a problem that necessitates a maintenance request or repair. As shown in FIG. 1A, a user of user interface 100 may note a problem with a pump in a plant during a manufacturing process. The user may enter into the user interface 100 a description of the issue. The system is configured to output a predicted result 106 based on the issue description (i.e., the text-based input 102) provided by the user of the user interface 100. The system is also configured to output an explanation 104 for the predicted result 106. In some implementations, the explanation 104 is configured to become visible to a user of the user interface 100 when the user hovers, e.g., by a cursor, over a portion of the user interface 100. In the example of FIG. 1A, hovering over the question mark displayed next to the predicted result 106 causes the explanation 104 to be shown on the user interface 100.

As shown in FIG. 1A, the predicted result 106 that is output by the system via the user interface 100 may be a damage code. In some implementations, the damage code may be a standardized field comprising, for example, a series of digits. Each digit in the series of digits may represent an aspect of a problem that is solved by a maintenance request. In the example of FIG. 1A, the damage code is a four-digit number. In some implementations, the damage code may be three digits. The damage code may be use case dependent. The damage code might reflect a hierarchical data structure wherein each digit of the damage code represents a level in the hierarchy. The predicted result 106 need not be a damage code, and the user of the user interface 100 may supply at least a first text-based input 102 and receive an explanation 104 for a predicted result 106. For example, in the respective fields of finance, sales, and procurement, the predicted result 106 may be a determination of fraudulency of a transaction, an assessment of how promising a sales lead may be, or a risk level of a supplier.

FIG. 1B depicts a table 120 containing various examples of descriptions or text-based inputs that may be entered into the user interface 100 of FIG. 1A as at least the first text-based input 102. FIG. 1B shows that each text-based input 102 of FIG. 1B has associated therewith a corresponding predicted result 106 (in the example of FIG. 1B, a damage code). The first machine learning (ML) model described herein may be configured to predict the predicted result 106 based on the text-based input 102. The systems described herein are further configured to determine an explanation 104 for the prediction of the predicted result 106.

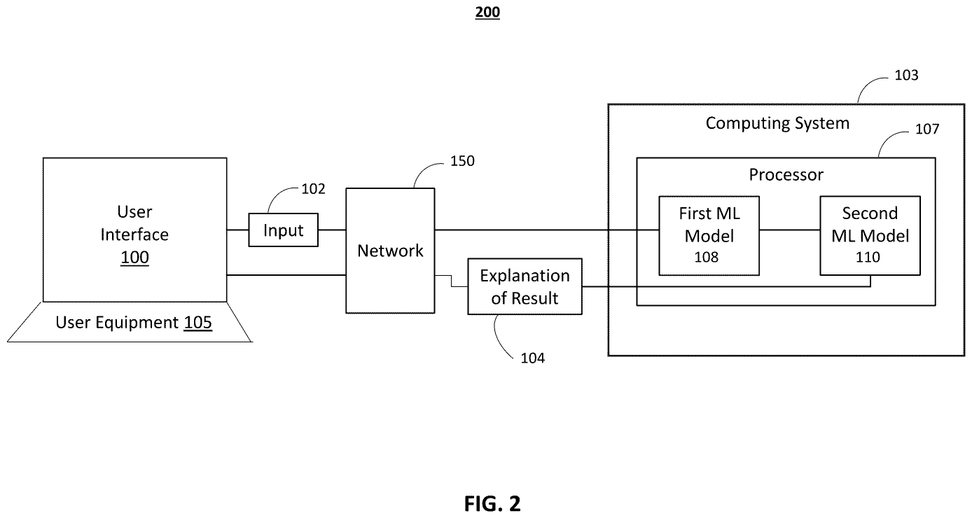

FIG. 2 depicts an example of a system 200 consistent with implementations of the current subject matter. The system 200 may include a user equipment 105, such as a computer, laptop, smartphone, tablet, and/or the like. The user equipment 105 may further include a user interface 100. The user interface 100 may be, for example, the user interface 100 of FIG. 1A.

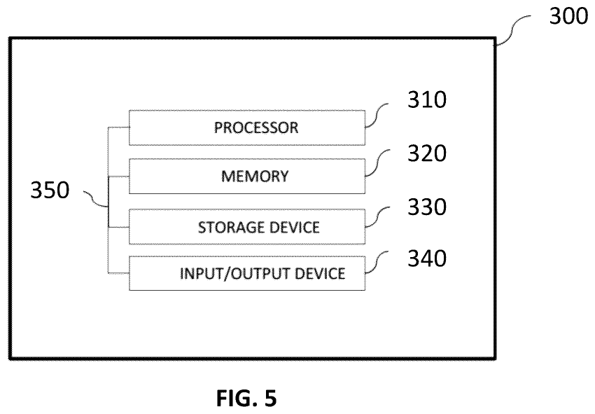

The user equipment 105 may couple, via network 150 (e.g., the Internet and/or any other communication mechanism), to a computing system 103 comprising one or more processors 107 and one or more memory as further described with respect to FIG. 5. The processors 107 of the computing system 103 may be configured to run a first machine learning (ML) model 108 and a second ML model 110.

A user of the user interface 100 may input at least a first text-based input 102 describing a maintenance issue or a plurality of maintenance issues to computing system 103 via user interface 100 of user equipment 105. At least the first text-based input 102 may be sent via the network 150 to the computing system 103.

The computing system 103 may comprise a processor 107 configured to apply a first ML model 108 to the text-based input 102. The first ML model 108 may be configured to parse and tokenize the text-based input 102. The resultant tokens may comprise, for example, keywords or chunks of text found in at least the first text-based input 102. In some implementations, the tokens may comprise numerical representations of the keywords or chunks of text found in the text-based input 102. Filler words, also called stop-words, such as “and”, “so”, “the”, etc., may be removed from the text-based input 102 prior to the tokenization thereof by the first ML model 108.

Based on the parsing and the tokenization of the text-based input 102 by the first ML model 108, the computing system 103 may predict a predicted result 106 associated with at least the first text-based input 102. For example, upon receiving at least the first text-based input 102 in the description column of table 120 of FIG. 1B, the first ML model 108 may predict the corresponding predicted result 106 of table 120 of FIG. 1B. To generate an accurate predicted result 106, the first ML model 108 must be trained on similar samples of tokenized text-based inputs and corresponding predicted results (such as, for example, damage codes) using historical data. The more information-rich the tokens are, the better the first ML model 108 will be by being able to capture and learn from more of the signals in the data. To achieve information-rich tokenization, approaches such as term frequency-inverse document frequency (TF-IDF) and word/sentence embeddings may be used. To keep the size of embedding matrices manageable (especially if storage and compute resources are scarce), automated dimensionality reduction techniques like principal component analysis (PCA) may be used to compress the embedding space by reducing the number of columns in the embedding matrix. In addition to predicting the predicted result 106, the first ML model 108 may also be configured to autofill any number of fields in the user interface 100 that the user of the user equipment 105 might not have the knowledge to fill in on their own.

In the example of FIG. 1B, the predicted result 106 is a damage code. A damage code may be the predicted result 106 when the systems described herein are applied in a manufacturing setting. The systems described herein may be applied in other settings, such as sales, procurement, finance, and IT, in which case the predicted result 106 may be a different type of result. For example, in the respective fields of finance, sales, and procurement, the predicted result 106 may be a determination of fraudulency of a transaction, an assessment of how promising a sales lead may be, or a risk level of a supplier.

After tokenization of at least the first text-based input 102 by the first ML model 108, a second ML model 110 may determine an explanation, such as explanation 104 of FIG. 1A, for each predicted result 106. In some implementations, the second ML model 110 is an explanatory model. The second ML model 110 may be trained on at least the first text-based input 102 received by the first ML model 108 as well as on the corresponding predicted result 106 to determine the explanation 104.

In some implementations, the second ML model 110 may be configured to determine global explanations for the predicted result 106. In certain implementations, the second ML model 110 may be configured to determine local explanations for the predicted result 106.

Global explanations tend to be coarser and are best for when a user of the system seeks high-level insights. Global explanations 104 may be based on an overarching set of possible explanations that are constant with respect to the predicted result 106 output the first ML model 108. In each instance of a new text-based input 102, the systems described herein can draw on global explanations 104 to explain the predicted result 106 that is predicted by the first ML model 108.

For example, if the predicted result 106 predicted by the first ML model 108 is a damage code corresponding to a maintenance issue described by a text-based input 102, then an explanation 104 may comprise a global explanation and may be determined by the second ML model 110 may come from an overarching set of known explanations 104 for damage codes.

Global explanatory models may be configured to leverage historical data regarding at least the first text-based input 102 and predicted result 106 by deriving latent topics across all of the data. Each of the latent topics may be associated with at least a first keyword found in the historical data. Based on these historical data and the keywords found within them, global explanatory models derive the overarching set of known explanations that can be used to determine an explanation 104 for the predicted result 106 predicted by the first ML model 108.

For example, the second ML model 110 of the computing system 103 may be configured to determine an explanation 104 as to why a particular damage code was output as the predicted result 106 from the first ML model 108 in view of the text-based input 102 corresponding to the damage code. The explanation 104 generated by the second ML model 110 may be output and provided to the user interface 100 of the user equipment 105 over the network 150. In implementations in which the explanation 104 is a global explanation, to generate an explanation 104 for a damage code, the computing system 103 may leverage historical data regarding maintenance requests containing issue descriptions and subsequent information regarding the resolution of maintenance requests.

In some implementations, the second ML model 110 may be a topic model. The topic model may be configured to determine global explanations for the predicted result 106. The topic model may be, for example, a latent Dirichlet allocation (LDA) model or any other suitable Bayesian topic model. In implementations in which the second ML model 110 is a topic model, the second ML model 110 is applied to the text-based input 102 and the predicted result 106, as shown, for example, in FIG. 1B, to determine a plurality of topics potentially associated with the text-based input 102.

A global explanatory model can derive as many topics as the user of the system may wish. For example, the global explanatory model may be constrained to derive only five topics or as many as five hundred topics. The smaller the number of topics derived by the global explanatory model, generally, the coarser the explanations are. The larger the number of topics derived by the global explanatory mode, the more granular or detailed the explanations are.

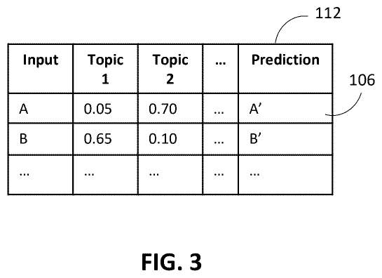

Applying the second ML model 110 to at least the first text-based input 102 and the predicted result 106 as shown in table 120 of FIG. 1B may yield a table such as table 112 of FIG. 3. The second ML model 110 may be configured to convert the column of the table 120 containing at least the first text-based input 102 (in the example of FIG. 1B, the leftmost column) via vectorization to a column representation, a vector embedding, or a numerical representation of the text in the column. In other words, the second ML model 110 may be configured to convert the column of the table 120 containing at least the first text-based input 102 to at least a first vectorized text-based input. By applying a topic model, such as LDA, to at least the first vectorized text-based input, the second ML model 110 may be configured to determine a plurality of topics potentially associated with at least the first text-based input 102. Each of these topics may have respective keywords associated therewith.

The second ML model 110 may also be configured to associate with at least the first text-based input 102 a feature importance score (FIS) describes the extent to which a segment, portion, keyword, or token of at least the first text-based input 102 is associated with a given topic of the determined plurality of topics. The FIS can be used to determine which input variable (i.e., which elements of the tokenization of the text-based input 102) are most important for predicting the predicted result 106. In some implementations, the FIS associated with at least the first text-based input 102 may be a binary FIS that signifies whether or not at least a portion of the tokenization of at least the first text-based input 102 is associated with a given topic of the determined plurality of topics. In some implementations, the FIS is a decimal value. A higher decimal value may indicate that at least a portion of the tokenization of at least the first text-based input is associated with a given topic of the plurality of topics more strongly than a lower decimal value.

By determining which topics have the highest FIS for a given predicted result, the second ML model 110 can determine the explanation for the predicted result 106. The second ML model 110 can communicate this explanation over network 150 to the user equipment 105.

As an example, after being trained on data such as data in table 120 of FIG. 1B, the second ML model 110 may be configured to generate a table such as table 112 of FIG. 3. For example, the global explanatory model may determine that Topic 1 having associated with keywords “valve” and “switch”. The global explanatory model may determine Topic 2 having associated keywords “pump” and “flow”.

The table 112 associates with each text-based input 102 an FIS that the text-based input 102 is associated with a given topic of the plurality of topics determined by the second ML model 110. The table 112 may be an intermediate result generated by the first ML model 108, and as such the table 112 may not be returned to the user of the user equipment 105. Instead, in some implementations, the processor 107 may retain the table 112.

As shown in FIG. 3, the table 112 may comprise in a first column the plurality of inputs A, B, . . . to which the first ML model 108 is applied. The inputs A, B, . . . of the table 112 may comprise, for example, at least the first text-based input 102 received from user equipment 105. The table 112 of FIG. 3 may comprise a plurality of topics Topic 1, Topic 2, . . . that are determined to be potentially associated with at least the first text-based input 102 by the second ML model 110.

The table 112 may also comprise, for at least the first text-based input 102 A, B, . . . and for each of the plurality of topics Topic 1, Topic 2, . . . , an FIS that at least some portion of the tokenization of at least the first text-based input 102 A, B, is associated with a respective topic Topic 1, Topic 2, . . . of a plurality of topics. These FISs may be computed by the second ML model 110 once the second ML model 110 is applied to the data in the table 120 of FIG. 1B.

For example, as shown in FIG. 3, the table 112 comprises an FIS of 0.05 that the text-based input A is associated with Topic 1 and an FIS of 0.70 that the text-based input A is associated with Topic 2. The table 112 further comprises an FIS of 0.65 that the input B is associated with Topic 1, and further comprises an FIS of 0.1 that the input B is associated with Topic 2. The second ML model 110 takes the data in the table 112 as a basis to find correlations between at least the first text-based input 102 and the predicted result 106.

The data in the table 112 may be used to determine an explanation 104, for example, comprising a global explanation, for a predicted result 106. For example, the second ML model 110 may take the topic in table 112 having the highest FIS in a given row as an explanation 104 for why a particular predicted result 106 was predicted for at least the first text-based input 102. The second ML model 110 may present to the user equipment 105 via network 150 the explanation 104 for the predicted result 106.

In some implementations, the second ML model 110 is an explanatory model configured to generate an explanation 104 for a predicted result 106 predicted by the first ML model 108. The explanation 104 may comprise a local explanation. Local explanations may differ widely across prediction instances (i.e., local explanations may vary strongly depending on the text-based input 102 provided to the computing system 103), and as such, local explanations may offer fine-grained insights for individual predictions. In certain implementations, when the explanation 104 for a predicted result 106 predicted by the first ML model 108 that is generated by the second ML model 110 is a local explanation, it is assumed that there exists at least one token (as determined by the tokenization of the text-based input 102) that explains the mapping between a text-based input 102 and a predicted result 106.

An explanation 104 that comprises a local explanation may be determined using k-splits, i.e., by tokenization of a given text-based input into k tokens. The explanation 104 that comprises a local explanation may be determined by reapplying the first ML model 108 to the tokens, rather than to at least the first text-based input 102, as inputs to derive at least a first token-level predicted result 106.

At least the first token-level predicted result may be quantified. At least the first token-level predicted result may be compared to the predicted result 106 that was based off of the text-based input 102 (i.e., the input-level predicted result 106) to determine a closeness therebetween. If the predicted result 106 is a numerical value, then a measure like absolute error between the token-level predicted result and the input-level predicted result 106 can be used to describe the closeness. For unordered, categorical data (i.e., colors, damage codes, etc.), a numerical representation of the embedding of the input in a multidimensional embedding space may be used to compute a notion of distance in the embedding space. This notion of distance (i.e., the Euclidean or the cosine distance) can be used to assess the closeness of the predicted token-level result to the input-level predicted result 106. When the explanation 104 is a local explanation, a predicted token-level result having a smallest closeness to the predicted input-level result can be returned by the second ML model 110 as the explanation 104 for the input-level predicted result 106.

In some implementations when the explanation 104 comprises a local explanation, it may be that a single token does not provide as appropriate an explanation 104 as do two tokens together. Masking may be used in implementations in which the explanation 104 is a local explanation and in which two tokens together provide the best explanation 104 for a predicted result 106. Masking allows for an explanation 104 to be generated that span multiple tokens, which allows for interdependencies between tokens to be considered when determining explanations 104 that are local.

To determine a local explanation by masking, a masking function is applied k times to each text-based input 102 to create at least a first masked text-based input. If n text-based inputs are originally received, the masking function is run nk times. The result of running the masking function on at least the first text-based input 102 may be a table having nk rows (i.e., the original dataset comprising at least the first text-based input 102 may be augmented by a factor of k). The masking function may be chosen so that different parts of at least the first text-based input 102 are masked in each of the k applications of the masking function.

Given the masked inputs, a masked result can be predicted. A masked predicted result 106 can be compared to at least the first predicted result 106 to determine a closeness therebetween. In implementations in which the explanation 104 is a local explanation, the unmasked portions of the masked input that yield the masked result that is closest to the input-level predicted result 106 of the first ML model 108 may be used for the explanation 104.

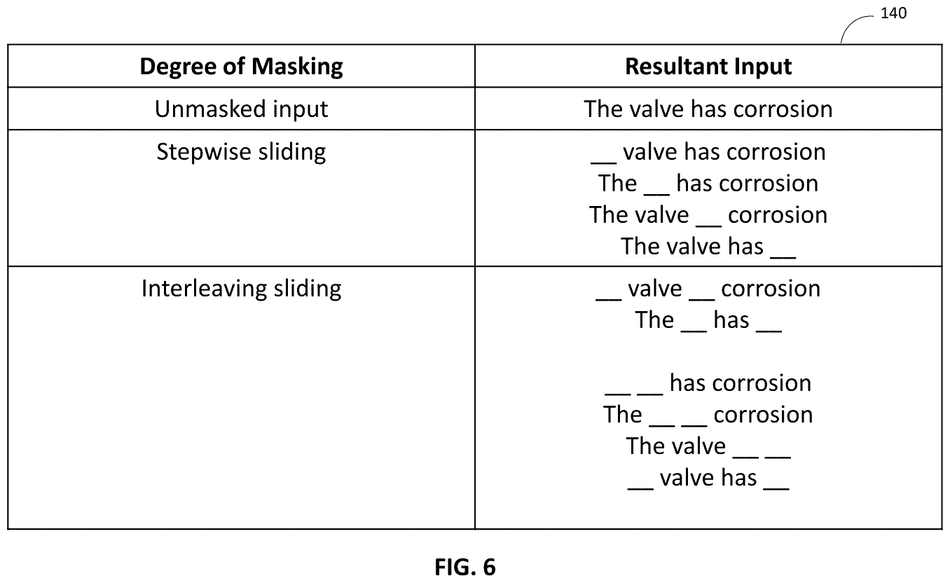

Masking of at least the first text-based input 102 may occur using various schema. For example, masking may be done according to deterministic patterns, as shown in FIG. 6. The second row of the table of FIG. 6 shows stepwise masking. In stepwise masking, a sequential word or character is masked in each iteration of the masking function. While the first row of the table in FIG. 6 shows single stepwise masking, masking may be done with any number of steps. Masking may also be done via interleaving sliding. Interleaving sliding may mask words or characters in at least the first text-based input 102 that are not adjacent to one another. Similarly, interleaving sliding may mask several words or characters in a given text-based input.

Masking may also be done by randomly masking a proportion p of a text-based input 102. Any appropriate distribution, i.e., a Bernoulli or a Gaussian distribution, can be used to determine the proportion p of the text-based input 102 that is masked.

Masking can also be performed by combining deterministic sliding and random masking for use cases informed by domain knowledge. In some implementations, masking can be performed with a custom randomization function or a custom sliding pattern. Increasing the sample size of inputs (i.e., up-sampling) by masking allows for a greater likelihood of finding an optimal masked version of the text-based input 102, and allows for a more generalizable model to be found, but it does so at the cost of more time and resources required to evaluate the predicted result for all masked versions of the input. The trade-off can be assessed on a case-by-case basis so that an appropriate level of masking is always used.

Generating local explanations by masking addresses the limitations of the k-split approach in which a local explanation is derived based on only a single token. However, masking approaches share a limitation in that the length of the text-based input 102 may affect the explanatory power and response time of the explanatory models. The longer the text, the more information the explanatory model has to go by, and hence the better the explanations are likely to be. But at the same time, processing longer texts can be more resource-intensive and time-consuming, and may thus increase the cost and response time of the explanatory models (which may become an issue for resource/time-critical use cases, e.g., involving real-time predictions on edge devices).

While the illustrated example of FIGS. 1-3 relates to the determination of an explanation of a damage code in a manufacturing context, the systems and methods described herein can also be used, for example, in sales, procurement, finance, and IT. In an IT setting, for example, a user of a laptop may log an issue with the laptop using a text-based input. A first ML model may predict a result associated with the text-based input describing the laptop issue. A technician responding to the laptop issue may use the explanation for the predicted result in determining how to resolve the laptop issue.

In some implementations, it may be that the token that explains the mapping of the text-based input to the predicted output is a piece or element of text that is not included in the text-based input.

To generate a local explanation, the second ML model may be configured to find a correlation between k different subtexts and a given damage code. The text-to-damage-code model allows the determination of the most highly correlated subtext. In other words, the second ML model, in deriving a local explanation for a result predicted by the first ML, attempts to determine which piece of the text of a given description is most highly correlated with the predicted result of the first ML model. When a new description is received by the computing system, the second ML model (which has been trained on data, for example, comprising at least the first text-based input 102 initially received and corresponding predicted result 106) runs the k-split model and proposes as an explanation for the predicted result of the first ML model the subtext most highly correlated therewith, according to the k-split model.

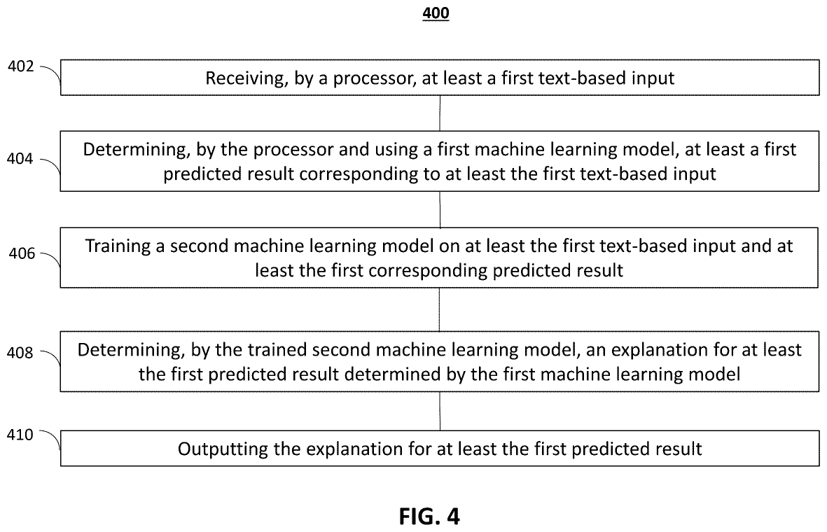

FIG. 4 depicts a process 400 (which may be a computer-implemented method) for determining explanations of AI-based predictions. The description of FIG. 4 also refers to FIGS. 1A-3.

At 402 of the process 400, a processor receives at least a first text-based input. The processor may be, for example, the processor 107 of FIG. 2 and the at least a first text-based input may be, for example, the text-based input 102 of FIGS. 1A, 1B, or 2.

At 404 of the process 400, the processor uses a first ML model to determine at least a first predicted result corresponding to at least the first text-based input. For example, the processor may use the first ML model 108 of FIG. 2 to compute the damage code shown as the predicted result 106 of FIGS. 1A and 1B.

At 406 406 of the process 400, the processor provides to a second ML model at least the first text-based input and at least the first corresponding predicted result. For example, the processor 107 of FIG. 2 may provide at least the first text-based input 102 of FIGS. 1A, 1B, and 2 and at least the first corresponding predicted result 106 of FIGS. 1A and 1B to the second ML model 110 of FIG. 2.

At 408 of the process 400, the second ML model determines an explanation for at least the first predicted result determined by the first ML model. For example, the second ML model 110 of FIG. 2 may determine an explanation 104 for at least the first corresponding predicted result 106 of FIGS. 1A and 1B.

At 410 of the process 400, the explanation 104 for at least the first corresponding predicted result 106 of FIGS. 1A and 1B is output. For example, the processor 107 of the computing system 103 of FIG. 2 may output the explanation 104. The explanation 104 may be output to the user interface 100 of user equipment 105 of FIG. 2.

FIG. 5 depicts a diagram illustrating an example of a system 300 consistent with implementations of the current subject matter. In some implementations, the current subject matter may be configured to be implemented in a system 300. For example, the methods for determining explanations of AI-based predictions described herein may be implemented using the system 300. The system may include a processor 310 (such as processor 107 of FIG. 2), a memory 320, a storage device 330, and an input/output device 340. Each of the components (e.g., processor 310, memory 320, storage device 330 and input/output device 340) may be interconnected using a system bus 350. The processor 310 may be configured to process instructions for execution within the system 300. In some implementations, the processor 310 may be a single-threaded processor. In alternate implementations, the processor 310 may be a multi-threaded processor.

The processor 310 may be configured to implement either or both of the first ML model 108 and the second ML model 110.

The processor 310 may be further configured to process instructions stored in the memory 320 or on the storage device 330, including receiving or sending information through the input/output device 340. The memory 320 may store information within the computing system 103. In some implementations, the memory 320 may be a non-transitory computer-readable medium. In alternate implementations, the memory 320 may be a volatile memory unit. In yet some implementations, the memory 320 may be a non-volatile memory unit. The storage device 330 may be capable of providing mass storage for the system 300. In some implementations, the storage device 330 may be a computer-readable medium. In alternate implementations, the storage device 130 may be a floppy disk device, a hard disk device, an optical disk device, a tape device, non-volatile solid-state memory, or any other type of storage device. The input/output device 340 may be configured to provide input/output operations for the system 300. In some implementations, the input/output device 340 may include a keyboard and/or pointing device. In alternate implementations, the input/output device 340 may include a display unit for displaying graphical user interfaces.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed implementations may be implemented in various environments. Such environments and related applications may be specially constructed for performing the various processes and operations according to the disclosed implementations or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed implementations, or it may be more convenient to construct a specialized apparatus or system to perform the required methods and techniques.

Although ordinal numbers such as first, second and the like may, in some situations, relate to an order; as used in a document, ordinal numbers do not necessarily imply an order. For example, ordinal numbers may be merely used to distinguish one item from another. For example, to distinguish a first event from a second event, but need not imply any chronological ordering or a fixed reference system (such that a first event in one paragraph of the description may be different from a first event in another paragraph of the description).

The foregoing description is intended to illustrate but not to limit the scope of the invention, which is defined by the scope of the appended claims. Other implementations are within the scope of the following claims.

These computer programs, which may also be referred to programs, software, software applications, applications, components, or code, include program instructions (i.e., machine instructions) for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium may store such program instructions non-transitorily, such as for example as would a non-transient solid-state memory or a magnetic hard drive or any equivalent storage medium. The machine-readable medium may alternatively or additionally store such machine instructions in a transient manner, such as would a processor cache or other random-access memory associated with one or more physical processor cores.

To provide for interaction with a user, the subject matter described herein may be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input.

The subject matter described herein may be implemented in a computing system that includes a back-end component, such as for example one or more data servers, or that includes a middleware component, such as for example one or more application servers, or that includes a front-end component, such as for example one or more client computers having a graphical user interface or a Web browser through which a user may interact with an implementation of the subject matter described herein, or any combination of such back-end, middleware, or front-end components. The components of the system may be interconnected by any form or medium of digital data communication, such as for example a communication network. Examples of communication networks include, but are not limited to, a local area network (“LAN”), a wide area network (“WAN”), and the Internet.

The computing system may include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A computer-implemented method comprising:
receiving, by a processor, at least a first text-based input;
determining, by the processor and using a first machine learning model, at least a first predicted result corresponding to at least the first text-based input;
training a second machine learning model on at least the first text-based input and at least the first corresponding predicted result;
determining, by the trained second machine learning model, an explanation for at least the first predicted result determined by the first machine learning model; and
outputting, to a user interface of user equipment, the explanation for at least the first predicted result.

Example 2. The computer-implemented method of example 1, wherein the second machine learning model is an explanatory model.

Example 3. The computer-implemented method of any of examples 1-2, wherein the explanatory model is configured to generate a global explanation for at least the first predicted result.

Example 4. The computer-implemented method of any of examples 1-3, wherein the explanatory model is a topic model.

Example 5. The computer-implemented method of any of examples 1-4, wherein the topic model is a latent Dirichlet allocation model.

Example 6. The computer-implemented method of any of examples 1-5, further comprising, by the topic model:
determining, for at least the first text-based input, a plurality of topics potentially associated with at least the first text-based input;
determining, for at least the first text-based input, a topic of the plurality of topics having a highest frequency important score associated with at least the first predicted result; and
outputting to the user interface, as the global explanation, the topic of the plurality of topics having the highest frequency importance score being associated with at least the first predicted result.

Example 7. The computer-implemented method of any of examples 1-6, wherein the explanatory model is configured to generate a local explanation for at least the first predicted result.

Example 8. The computer-implemented method of any of examples 1-7, wherein the explanatory model is configured to generate the local explanation for at least the first predicted result by tokenizing at least the first text-based input into a plurality of tokens.

Example 9. The computer-implemented method of any of examples 1-8, further comprising, for the plurality of tokens:
determining, by the processor and using the first machine learning model, at least a first token-level predicted result;
comparing at least the first token-level predicted result to at least the first predicted result to determine a closeness between at least the first token-level predicted result and at least the first predicted result; and
outputting to the user interface, as the local explanation, the token-level predicted result having a smallest closeness between the token-level predicted result and at least the first predicted result.

Example 10. The computer-implemented method of any of examples 1-9, further comprising, generating, by the explanatory model, the local explanation for at least the first predicted result by:
masking at least the first text-based input to create at least a first masked text-based input;
determining, for at least the first masked text-based input, at least a first masked predicted result;
comparing at least the masked predicted result to at least the first predicted result to determine a closeness between at least the first masked predicted result and at least the first predicted result. and
outputting to the user interface, as the local explanation, the masked predicted result having a smallest closeness between the masked predicted result and at least the first predicted result.

Example 11. A system comprising:
at least one processor; and
at least one memory including instructions which when executed by the at least one processor causes operations comprising:
receiving, by the at least one processor, at least a first text-based input;
determining, by the at least one processor and using a first machine learning model, at least a first predicted result corresponding to at least the first text-based input;
training a second machine learning model on at least the first text-based input and at least the first corresponding predicted result;
determining, by the trained second machine learning model, an explanation for at least the first predicted result determined by the first machine learning model; and
outputting, to a user interface of user equipment, the explanation for at least the first predicted result.

Example 12. The system of example 11, wherein the second machine learning model is an explanatory model.

Example 13. The system of any of examples 11-12, wherein the explanatory model is configured to generate a global explanation for at least the first predicted result.

Example 14. The system of any of examples 11-13, wherein the explanatory model is a topic model.

Example 15. The system of any of examples 11-14, wherein the explanatory model is configured to generate a local explanation for at least the first predicted result.

Example 16. A non-transitory computer-readable storage medium including instructions which when executed by at least one processor causes operations comprising:
receiving, by the at least one processor, at least a first text-based input;
determining, by the at least one processor and using a first machine learning model, at least a first predicted result corresponding to at least the first text-based input;
training a second machine learning model on at least the first text-based input and at least the first corresponding predicted result;
determining, by the trained second machine learning model, an explanation for at least the first predicted result determined by the first machine learning model; and
outputting, to a user interface of user equipment, the explanation for at least the first predicted result.

Example 17. The non-transitory computer-readable storage medium of example 16, wherein the second machine learning model is an explanatory model.

Example 18. The non-transitory computer-readable storage medium of any of examples 16-17, wherein the explanatory model is configured to generate a global explanation for at least the first predicted result.

Example 19. The non-transitory computer-readable storage medium of any of examples 16-18, wherein the explanatory model is a topic model.

Example 20. The non-transitory computer-readable storage medium of any of examples 16-19, wherein the explanatory model is configured to generate a local explanation for at least the first predicted result.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer-implemented method comprising:
receiving, by a processor, at least a first text-based input;
determining, by the processor and using a first machine learning model, at least a first predicted result corresponding to at least the first text-based input;
training a second machine learning model on at least the first text-based input and at least the first corresponding predicted result;
determining, by the trained second machine learning model, an explanation for at least the first predicted result determined by the first machine learning model; and
outputting, to a user interface of user equipment, the explanation for at least the first predicted result.

2. The computer-implemented method of claim 1, wherein the second machine learning model is an explanatory model.

3. The computer-implemented method of claim 2, wherein the explanatory model is configured to generate a global explanation for at least the first predicted result.

4. The computer-implemented method of claim 3, wherein the explanatory model is a topic model.

5. The computer-implemented method of claim 4, wherein the topic model is a latent Dirichlet allocation model.

6. The computer-implemented method of claim 4, further comprising, by the topic model:
determining, for at least the first text-based input, a plurality of topics potentially associated with at least the first text-based input;
determining, for at least the first text-based input, a topic of the plurality of topics having a highest frequency important score associated with at least the first predicted result; and
outputting to the user interface, as the global explanation, the topic of the plurality of topics having the highest frequency importance score being associated with at least the first predicted result.

7. The computer-implemented method of claim 2, wherein the explanatory model is configured to generate a local explanation for at least the first predicted result.

8. The computer-implemented method of claim 7, wherein the explanatory model is configured to generate the local explanation for at least the first predicted result by tokenizing at least the first text-based input into a plurality of tokens.

9. The computer-implemented method of claim 8, further comprising, for the plurality of tokens:
determining, by the processor and using the first machine learning model, at least a first token-level predicted result;
comparing at least the first token-level predicted result to at least the first predicted result to determine a closeness between at least the first token-level predicted result and at least the first predicted result; and
outputting to the user interface, as the local explanation, the token-level predicted result having a smallest closeness between the token-level predicted result and at least the first predicted result.

10. The computer-implemented method of claim 7, further comprising, generating, by the explanatory model, the local explanation for at least the first predicted result by at least:
masking at least the first text-based input to create at least a first masked text-based input;
determining, for at least the first masked text-based input, at least a first masked predicted result;
comparing at least the first masked predicted result to at least the first predicted result to determine a closeness between at least the first masked predicted result and at least the first predicted result; and
outputting to the user interface, as the local explanation, the masked predicted result having a smallest closeness between the masked predicted result and at least the first predicted result.

11. A system comprising:
at least one processor; and
at least one memory including instructions which when executed by the at least one processor causes operations comprising:
receiving, by the at least one processor, at least a first text-based input;
determining, by the at least one processor and using a first machine learning model, at least a first predicted result corresponding to at least the first text-based input;
training a second machine learning model on at least the first text-based input and at least the first corresponding predicted result;
determining, by the trained second machine learning model, an explanation for at least the first predicted result determined by the first machine learning model; and
outputting, to a user interface of user equipment, the explanation for at least the first predicted result.

12. The system of claim 11, wherein the second machine learning model is an explanatory model.

13. The system of claim 12, wherein the explanatory model is configured to generate a global explanation for at least the first predicted result.

14. The system of claim 13, wherein the explanatory model is a topic model.

15. The system of claim 12, wherein the explanatory model is configured to generate a local explanation for at least the first predicted result.

16. A non-transitory computer-readable storage medium including instructions which when executed by at least one processor causes operations comprising:
receiving, by the at least one processor, at least a first text-based input;
determining, by the at least one processor and using a first machine learning model, at least a first predicted result corresponding to at least the first text-based input;
training a second machine learning model on at least the first text-based input and at least the first corresponding predicted result;
determining, by the trained second machine learning model, an explanation for at least the first predicted result determined by the first machine learning model; and
outputting, to a user interface of user equipment, the explanation for at least the first predicted result.

17. The non-transitory computer-readable storage medium of claim 16, wherein the second machine learning model is an explanatory model.

18. The non-transitory computer-readable storage medium of claim 17, wherein the explanatory model is configured to generate a global explanation for at least the first predicted result.

19. The non-transitory computer-readable storage medium of claim 18, wherein the explanatory model is a topic model.

20. The non-transitory computer-readable storage medium of claim 17, wherein the explanatory model is configured to generate a local explanation for at least the first predicted result.
